(19) United States
(12) Patent Application Publication
(10) Pub. No.: US 2025/0087838 A1
(43) Pub. Date: Mar. 13, 2025

(54) BATTERY MODULE

(71) Applicant: Cheng Uei Precision Industry Co., Ltd., New Taipei City (TW)

(72) Inventors: Ta Chang Yang, New Taipei City (TW); Min Yu Wu, New Taipei City (TW)

(21) Appl. No.: 18/599,617

(22) Filed: Mar. 8, 2024

(30) Foreign Application Priority Data
Sep. 7, 2023 (CN) 202322435592.7

(51) Int. Cl. H01M 50/503; H01M 50/213; H01M 50/583

(52) U.S. Cl. CPC H01M 50/503; H01M 50/213; H01M 50/583; H01M 2200/103

(57) ABSTRACT

A battery module includes a plurality of battery cells, a first bracket disposed to top surfaces of the plurality of the battery cells, a second bracket disposed to bottom surfaces of the plurality of the battery cells, a plurality of first connecting plates disposed to a top surface of the first bracket, a plurality of second connecting plates and two third connecting plates. Each first connecting plate has a plurality of first slits. The plurality of the second connecting plates are disposed to a bottom surface of the second bracket. Each second connecting plate has a plurality of second slits. The two third connecting plates are disposed to two opposite sides of the first bracket. Each third connecting plate has a plurality of third slits.

### CROSS-REFERENCE TO RELATED APPLICATION

The present application is based on, and claims priority from, China Patent Application No. 202322435592.7, filed Sep. 7, 2023, the disclosure of which is hereby incorporated by reference herein in its entirety.

### BACKGROUND OF THE INVENTION

### 1. Field of the Invention

The present invention generally relates to a battery module, and more particularly to a battery module having a better current dividing effect of spot soldering and a better tension soldering effect.

### 2. Description of the Prior Art

Generally, a neck portion of a nickel plate of a conventional battery module is a fuse in a width direction. When a discharge current of a single battery cell is greater than a conductive current limit of the neck portion of the nickel plate, the fuse of the neck portion of the nickel plate is blown. Equivalently, each battery cell of the conventional battery module has the fuse, so that the fuse is used for preventing that the single battery cell is damaged or exploded.

The conventional battery module includes a first busbar and a second busbar connected to a power battery module. The power battery module has a plurality of battery units. The first busbar is connected to one electrode of each battery unit. The second busbar is connected to the other electrode of each battery unit. The first busbar and the second busbar define a plurality of through holes. Two ends of each battery unit are corresponding to two through holes. Each through hole has a contact plate. The contact plates of the two through holes contact with the two electrodes of each battery unit. Each contact plate is connected with a segment of one through hole by a fuse.

However, when the contact plates of the conventional battery module are soldered by a spot soldering technology, a current path of each contact plate of the conventional battery module is undivided, so the contact plates of the conventional battery module accumulate heat. The fuses of the neck portions of the contact plates of the conventional battery module are easy to break.

Thus, it is essential to provide an innovative battery module having a better current dividing effect of spot soldering and a better tension soldering effect.

### SUMMARY OF THE INVENTION

An object of the present invention is to provide a battery module having a better current dividing effect of spot soldering and a better tension soldering effect. The battery module includes a plurality of battery cells, a first bracket disposed to top surfaces of the plurality of the battery cells, a second bracket disposed to bottom surfaces of the plurality of the battery cells, a plurality of first connecting plates disposed to a top surface of the first bracket, a plurality of second connecting plates and two third connecting plates. Each first connecting plate has a first base plate, a plurality of first circular grooves, a plurality of first openings, a plurality of first fuse parts, a plurality of first contact plates and a plurality of first slits. The first base plate is a substantially rectangular structure. The plurality of the first circular grooves penetrate through a top surface and a bottom surface of the first base plate. The plurality of the first circular grooves are arranged in a first left row and a first right row. A segment of each first circular groove protrudes transversely to form a first opening. Orientations of the first openings of the first circular grooves of the first left row are the same. Orientations of the first openings of the first circular grooves of the first right row are the same. The orientations of the first openings of the first circular grooves of the first left row are opposite to the orientations of the first openings of the first circular grooves of the first right row. The first openings of the first circular grooves of the first left row are longitudinally arranged in a second left row, and the first openings of the first circular grooves of the first right row are longitudinally arranged in a second right row. The first openings of the second left row face towards the first openings of the second right row. The plurality of the first fuse parts are corresponding to the plurality of the first openings. Each first fuse part is disposed in one first opening. The plurality of the first contact plates are disposed in the plurality of the first circular grooves. Each first contact plate contacts with a positive electrode or a negative electrode of one battery cell. The plurality of the first slits penetrate through middles of top surfaces and bottom surfaces of the plurality of the first contact plates. One end of each first slit is opened freely, and the one end of each first slit is communicated with one first circular groove. The other end of each first slit is closed. The other end of each first slit keeps a distance from the one first circular groove. The plurality of the second connecting plates are disposed to a bottom surface of the second bracket. Each second connecting plate has a second base plate, a plurality of second circular grooves, a plurality of second openings, a plurality of second fuse parts, a plurality of second contact plates and a plurality of second slits. The second base plate is a long strip structure. The plurality of the second circular grooves penetrate through a top surface and a bottom surface of the second base plate. The plurality of the second circular grooves are longitudinally arranged in a first front row and a first rear row. A segment of each second circular groove protrudes longitudinally to form a second opening. The plurality of the second openings are arranged in a second front row and a second rear row. Orientations of the second openings of the second front row are opposite to an orientation of the second opening of the second rear row. The second openings of the second front row face rearward. The second opening of the second rear row faces frontward. The plurality of the second fuse parts are corresponding to the plurality of the second openings. Each second fuse part is disposed in one second opening. The plurality of the second contact plates are disposed in the plurality of the second circular grooves. Each second contact plate contacts with the positive electrode or the negative electrode of the one battery cell. The plurality of the second slits penetrate through middles of top surfaces and bottom surfaces of the plurality of the second contact plates. One end of each second slit is opened freely, and the one end of each second slit is communicated with one second circular groove. The other end of each second slit is closed. The other end of each second slit keeps a distance from the one second circular groove. The two third connecting plates are disposed to two opposite sides of the first bracket. The two third connecting plates are disposed to two opposite sides of the plurality of the first connecting plates. Each third connecting plate has a third base plate, a first current collecting portion, a plurality of third circular grooves, a plurality of third openings, a plurality of third fuse parts, a plurality of third contact plates and a plurality of third slits. The first current collecting portion is extended downward from an outer side of the third base plate. The plurality of the third circular grooves penetrate through a top surface and a bottom surface of the third base plate. A segment of each third circular groove protrudes outward and transversely to form a third opening. The third openings of the two third base plates of the two third connecting plates face towards the two first current collecting portions of the two third connecting plates. The plurality of the third fuse parts are corresponding to the plurality of the third openings. Each third fuse part is disposed in one third opening. The plurality of the third contact plates are disposed in the plurality of the third circular grooves. Each third contact plate contacts with the positive electrode or the negative electrode of the one battery cell. The plurality of the third slits penetrate through middles of top surfaces and bottom surfaces of the plurality of the third contact plates. One end of each third slit is opened freely, and the one end of each third slit is communicated with one third circular groove. The other end of each third slit is closed. The other end of each third slit keeps a distance from the one third circular groove.

Another object of the present invention is to provide a battery module. The battery module includes a plurality of battery cells, a first bracket disposed to top surfaces of the plurality of the battery cells, a second bracket disposed to bottom surfaces of the plurality of the battery cells, a plurality of first connecting pieces and two second connecting pieces. The plurality of the first connecting pieces are disposed to the top surface of the first bracket and the bottom surface of the second bracket. Each first connecting piece has a first base slice, a plurality of first circular spaces, a plurality of first gaps, a plurality of first contact slices, a plurality of first fuse elements and a plurality of first slots. The first base slice is a rectangular strip structure. The plurality of the first circular spaces penetrate through a top surface and a bottom surface of the first base slice. The plurality of the first circular spaces are arranged in a first left line and a first right line. A segment of each first circular space protrudes transversely to form a first gap. Orientations of the first gaps of the first circular spaces of the first left line are the same. Orientations of the first gaps of the first circular spaces of the first right line are the same. The orientations of the first gaps of the first circular spaces of the first left line are opposite to the orientations of the first gaps of the first circular spaces of the first right line. The plurality of the first contact slices are disposed in the plurality of the first circular spaces. Each first contact slice contacts with the positive electrode or the negative electrode of the one battery cell. The plurality of the first fuse elements are corresponding to the plurality of the first gaps. Each first fuse element is disposed in one first gap. The plurality of the first slots penetrate through middles of top surfaces and bottom surfaces of the plurality of the first contact slices. One end of each first slot is opened freely, and the one end of each first slot is communicated with one first circular space. The other end of each first slot is closed. The other end of each first slot keeps a distance from the one first circular space. The two second connecting pieces are disposed at a left side and a right side of the first bracket. The two second connecting pieces are disposed to two opposite sides of the plurality of first connecting pieces. Each second connecting piece has a second base slice, a second current collecting portion extended downward from an outer side of the second base slice, a plurality of second circular spaces, a plurality of second gaps, a plurality of second contact slices, a plurality of second fuse elements and a plurality of second slots. The plurality of the second circular spaces penetrate through a top surface and a bottom surface of the second base slice. A segment of each second circular space protrudes outward to form a second gap. The second gaps of the two second base slices of the two second connecting pieces face towards the two second current collecting portions of the two second connecting pieces. The plurality of the second contact slices are disposed in the plurality of the second circular spaces. Each second contact slice contacts with the positive electrode or the negative electrode of the one battery cell. The plurality of the second fuse elements are corresponding to the plurality of the second gaps. Each second fuse element is disposed in one second gap. The plurality of the second slots penetrate through middles of top surfaces and bottom surfaces of the plurality of the second contact slices. One end of each second slot is opened freely, and the one end of each second slot is communicated with one second circular space. The other end of each second slot is closed. The other end of each second slot keeps a distance from the one second circular space.

Another object of the present invention is to provide a battery module. The battery module includes a plurality of battery cells, a first bracket disposed to top surfaces of the plurality of the battery cells, a second bracket disposed to bottom surfaces of the plurality of the battery cells, a plurality of first connecting pieces and two second connecting pieces. The plurality of the first connecting pieces are disposed to the top surface of the first bracket and the bottom surface of the second bracket. Each first connecting piece has a first base slice, a plurality of first circular spaces, a plurality of first gaps, a plurality of first contact slices, a plurality of first fuse elements, a plurality of first slots and a plurality of first locating grooves. The plurality of the first circular spaces penetrate through a top surface and a bottom surface of the first base slice. The plurality of the first circular spaces are arranged in a first left line and a first right line. A segment of each first circular space protrudes transversely to form a first gap. Orientations of the first gaps of the first circular spaces of the first left line are the same. Orientations of the first gaps of the first circular spaces of the first right line are the same. The orientations of the first gaps of the first circular spaces of the first left line are opposite to the orientations of the first gaps of the first circular spaces of the first right line. The plurality of the first contact slices are disposed in the plurality of the first circular spaces. Each first contact slice contacts with the positive electrode or the negative electrode of the one battery cell. Each first fuse element is disposed in one first gap. The plurality of the first slots penetrate through middles of top surfaces and bottom surfaces of the plurality of the first contact slices. One end of each first slot is opened freely, and the one end of each first slot is communicated with one first circular space. The other end of each first slot is closed. The other end of each first slot keeps a distance from the one first circular space. The plurality of the first locating grooves penetrate through the top surface and the bottom surface of the first base slice. Each first locating groove is disposed among four adjacent first circular spaces. The plurality of the first locating grooves of the plurality of the first connecting pieces are located to the first bracket and the second bracket. The two second connecting pieces are disposed at a left side and a right side of the first bracket. The two second connecting pieces are disposed to two opposite sides of the plurality of first connecting pieces. Each second connecting piece has a second base slice, a second current collecting portion extended downward from an outer side of the second base slice, a plurality of second circular spaces, a plurality of second gaps, a plurality of second contact slices, a plurality of second fuse elements and a plurality of second slots. The plurality of the second circular spaces penetrate through a top surface and a bottom surface of the second base slice. A segment of each second circular space protrudes outward to form a second gap. The second gaps of the two second base slices of the two second connecting pieces face towards the two second current collecting portions of the two second connecting pieces. The plurality of the second contact slices are disposed in the plurality of the second circular spaces. Each second contact slice contacts with the positive electrode or the negative electrode of the one battery cell. Each second fuse element is disposed in one second gap. The plurality of the second slots penetrate through middles of top surfaces and bottom surfaces of the plurality of the second contact slices. One end of each second slot is opened freely, and the one end of each second slot is communicated with one second circular space. The other end of each second slot is closed. The other end of each second slot keeps a distance from the one second circular space.

As described above, a first current direction of each first connecting plate is an one-way loop design, a second current direction of each second connecting plate is the one-way loop design, and a third current direction of each third connecting plate is the one-way loop design by designs of the first slit of each first connecting plate, the second slit of each second connecting plate and the third slit of each third connecting plate of the battery module, so the plurality of the first connecting plates, the plurality of the second connecting plates and the two third connecting plates are difficult to accumulate the heat. a fourth current direction of each first connecting piece is the one-way loop design, and a fifth current direction of each second connecting piece is the one-way loop design by designs of the first slot of each first connecting piece and the second slot of each second connecting piece of the battery module, so the plurality of the first connecting pieces and the plurality of the second connecting pieces are difficult to accumulate the heat. The plurality of the first fuse parts, the plurality of the second fuse parts and the plurality of the third fuse parts are difficult to break, so the battery module has the better current dividing effect of spot soldering and the better tension soldering effect. The plurality of the first fuse elements and the plurality of the second fuse elements are difficult to break, so the battery module has the better current dividing effect of spot soldering and the better tension soldering effect. Furthermore, the third openings of the two third base plates of the two third connecting plates face towards the two first current collecting portions of the two third connecting plates, so that currents of external electronic components averagely flow through the third openings of the two third connecting plates. The second gaps of the two second base slices of the two second connecting pieces face towards the two second current collecting portions of the two second connecting pieces, so that the currents of the external electronic components averagely flow through the second gaps of the two second connecting pieces.

### BRIEF DESCRIPTION OF THE DRAWINGS

The present invention will be apparent to those skilled in the art by reading the following description, with reference to the attached drawings, in which:

FIG. 1 is a perspective view of a battery module in accordance with a first preferred embodiment of the present invention;

FIG. 2 is another perspective view of the battery module of FIG. 1;

FIG. 3 is an exploded view of the battery module of FIG. 1;

FIG. 4 is another exploded view of the battery module of FIG. 1;

FIG. 5 is a perspective view of a first connecting plate of the battery module of FIG. 1;

FIG. 6 is a perspective view of a second connecting plate of the battery module of FIG. 1;

FIG. 7 is a perspective view of a third connecting plate of the battery module of FIG. 1;

FIG. 8 is a perspective view of a battery module in accordance with a second preferred embodiment of the present invention;

FIG. 9 is another perspective view of the battery module of FIG. 8;

FIG. 10 is a perspective view of a first connecting piece of the battery module of FIG. 8; and

FIG. 11 is a perspective view of a second connecting piece of the battery module of FIG. 8.

### DETAILED DESCRIPTION OF THE INVENTION

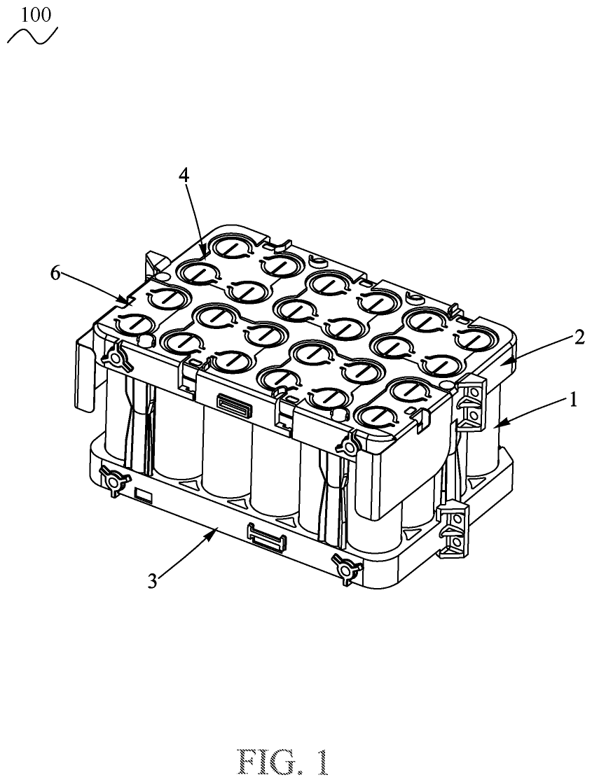

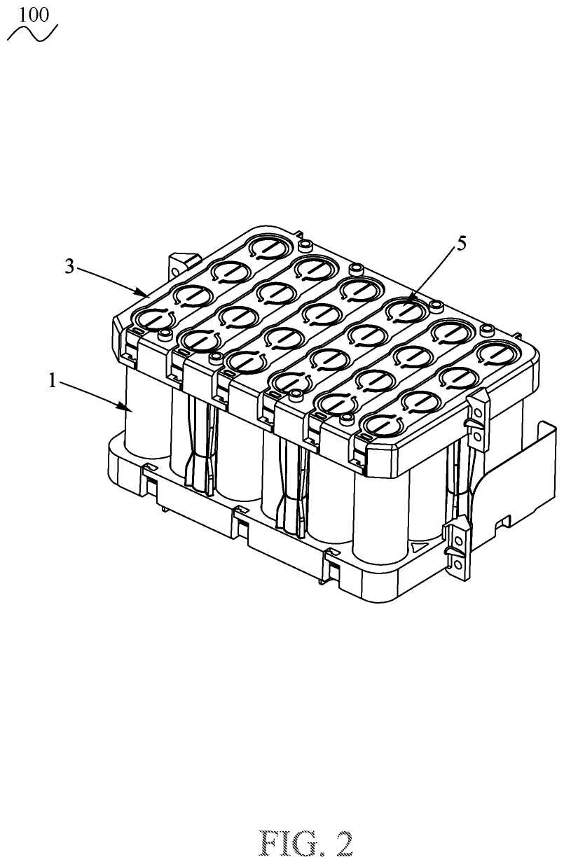

With reference to FIG. 1 to FIG. 4, a battery module 100 in accordance with a first preferred embodiment of the present invention is shown. The battery module 100 includes a plurality of battery cells 1, a first bracket 2, a second bracket 3, a plurality of first connecting plates 4, a plurality of second connecting plates 5 and two third connecting plates 6. In the first preferred embodiment, the plurality of the first connecting plates 4, the plurality of the second connecting plates 5 and the two third connecting plates 6 are integrally formed by stamping a nickel metal. In a concrete implementation, the plurality of the first connecting plates 4, the plurality of the second connecting plates 5 and the two third connecting plates 6 are without being integrally formed by stamping the nickel metal.

The first bracket 2 is disposed to top surfaces of the plurality of the battery cells 1. The second bracket 3 is disposed to bottom surfaces of the plurality of the battery cells 1. The plurality of the battery cells 1 are disposed between the first bracket 2 and the second bracket 3. The plurality of the first connecting plates 4 are disposed to a top surface of the first bracket 2. The plurality of the second connecting plates 5 are disposed to a bottom surface of the second bracket 3. The two third connecting plates 6 are disposed to the first bracket 2. The plurality of the first connecting plates 4 are disposed to a middle of the first bracket 2. The two third connecting plates 6 are disposed to two opposite sides of the first bracket 2.

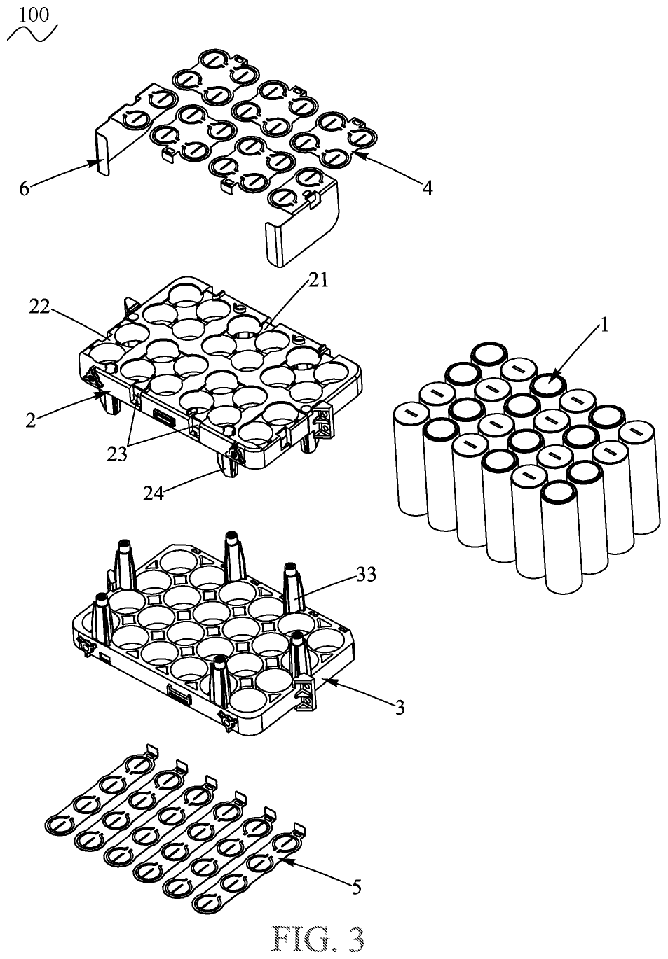

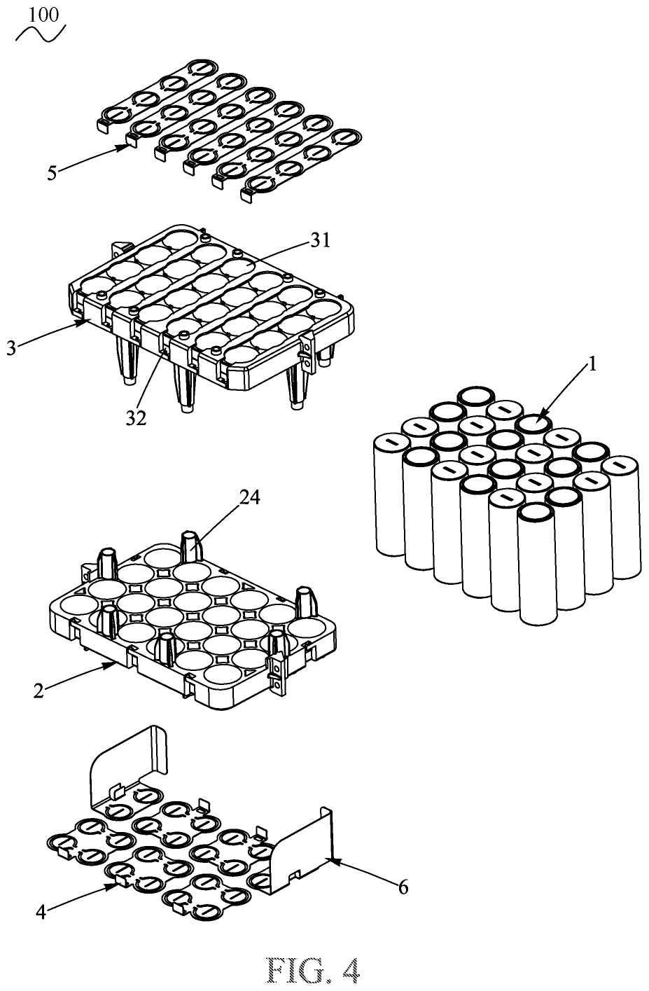

Referring to FIG. 3 and FIG. 4, the first bracket 2 has a plurality of first concave surfaces 21, two second concave surfaces 22, a plurality of first restricting portions 23 and a plurality of first location portions 24. Several portions of the top surface of the first bracket 2 are recessed downward to form the plurality of the first concave surfaces 21. The plurality of the first connecting plates 4 are disposed on the plurality of the first concave surfaces 21. Two rears of two opposite sides of the top surface of the first bracket 2 are recessed downward to form the two second concave surfaces 22. The two third connecting plates 6 are disposed on the two second concave surfaces 22. A front and a rear of the top surface of the first bracket 2 are recessed downward to form the plurality of the first restricting portions 23. An outer end of each first concave surface 21 is recessed downward to form a first restricting portion 23. Corresponding mechanisms of the plurality of the first connecting plates 4 are fastened in the plurality of the first restricting portions 23 to realize that the plurality of the first connecting plates 4 are located to the first bracket 2, and the plurality of the first connecting plates 4 are fixed to the first bracket 2. Several portions of a bottom surface of the first bracket 2 extend downward to form the plurality of the first location portions 24. The plurality of the first location portions 24 are corresponding to corresponding mechanisms of the second bracket 3.

Referring to FIG. 3 and FIG. 4, the second bracket 3 has a plurality of third concave surfaces 31, a plurality of second restricting portions 32 and a plurality of second location portions 33. Several portions of the bottom surface of the second bracket 3 are recessed upward to form the plurality of the third concave surfaces 31. The plurality of the second connecting plates 5 are disposed at the plurality of the third concave surfaces 31. A rear of the bottom surface of the second bracket 3 are recessed upward to form the plurality of the second restricting portions 32. One end of the third concave surface 31 is recessed upward to form a second restricting portion 32. Corresponding mechanisms of the plurality of the second connecting plates 5 are fastened in the plurality of the second restricting portions 32 to realize that the plurality of the second connecting plates 5 are located to the second bracket 3, and the plurality of the second connecting plates 5 are fixed to the second bracket 3. Several portions of a top surface of the second bracket 3 extend upward to form the plurality of the second location portions 33. The plurality of the second location portions 33 are corresponding to the plurality of the first location portions 24 of the first bracket 2. The corresponding mechanisms of the second bracket 3 are the plurality of the second location portions 33 of the second bracket 3.

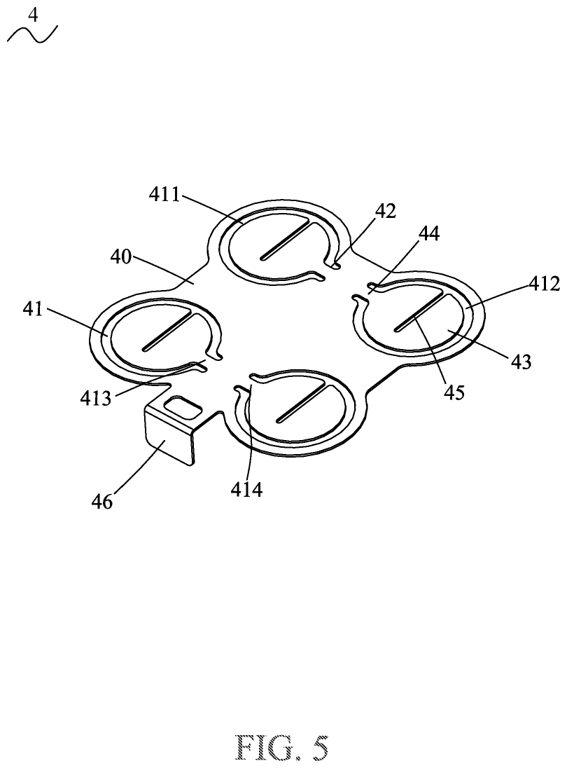

Referring to FIG. 5, each first connecting plate 4 has a first base plate 40, a plurality of first circular grooves 41, a plurality of first openings 42, a plurality of first contact plates 43, a plurality of first fuse parts 44, a plurality of first slits 45 and a first buckling portion 46. In the first preferred embodiment, the first base plate 40 is a substantially rectangular structure. The plurality of the first connecting plate 4 are arranged as rectangular structures.

The plurality of the first circular grooves 41 penetrate through a top surface and a bottom surface of the first base plate 40. The plurality of the first circular grooves 41 of each first connecting plate 4 are arranged in a first left row 411 and a first right row 412. In the first preferred embodiment, each first base plate 40 has four first circular grooves 41, four first openings 42, four first contact plates 43, four first fuse parts 44 and four first slits 45. A segment of each first circular groove 41 protrudes transversely to form a first opening 42. The first opening 42 is disposed transversely. The plurality of the first openings 42 are perpendicular to the plurality of the first slits 45. In the first preferred embodiment, the four first circular grooves 41 of each first connecting plate 4 are arranged in two rows. The two first circular grooves 41 of each first connecting plate 4 are longitudinally arranged in the first left row 411, and the other two first circular grooves 41 of each first connecting plate 4 are longitudinally arranged in the first right row 412. The two rows of the first circular grooves 41 of the first base plate 40 of each first connecting plate 4 are arranged at a left side and a right side of the first base plate 40 of each first connecting plate 4, specifically, the first circular grooves 41 of the first left row 411 are disposed to the left side of the first base plate 40, and the first circular grooves 41 of the first right row 412 are disposed to the right side of the first base plate 40. Orientations of the first openings 42 of the first circular grooves 41 of the first left row 411 are the same. Orientations of the first openings 42 of the first circular grooves 41 of the first right row 412 are the same. The orientations of the first openings 42 of the first circular grooves 41 of the first left row 411 are opposite to the orientations of the first openings 42 of the first circular grooves 41 of the first right row 412. The first openings 42 of the first circular grooves 41 of the first left row 411 face towards the first openings 42 of the first circular grooves 41 of the first right row 412. In the preferred embodiment, the first openings 42 of the first circular grooves 41 of the first left row 411 face towards a rightward direction. The first openings 42 of the first circular grooves 41 of the first right row 412 face towards a leftward direction.

In the first preferred embodiment, the two first openings 42 of the first circular grooves 41 of the first left row 411 are longitudinally arranged in a second left row 413, and the other two first openings 42 of the first circular grooves 41 of the first right row 412 are longitudinally arranged in a second right row 414. The two first openings 42 of the second left row 413 are formed by two right sides of the two first circular grooves 41 of the first left row 411. The other two first openings 42 of the second right row 414 are formed by two left sides of the other two first circular grooves 41 of the first right row 412. The orientations of the two first openings 42 of the second left row 413 are the same. The orientations of the other two first openings 42 of the second right row 414 are the same. The two first openings 42 of the second left row 413 face towards the other two first openings 42 of the second right row 414. The two first openings 42 of the second left row 413 face towards the rightward direction. The other two first openings 42 of the second right row 414 face towards the leftward direction.

The plurality of the first contact plates 43 are disposed in the plurality of the first circular grooves 41. Each first contact plate 43 is corresponding to a positive electrode or a negative electrode of one battery cell 1. Each first contact plate 43 contacts with the positive electrode or the negative electrode of the one battery cell 1. The plurality of the first contact plates 43 are connected with the first base plate 40 by the plurality of the first fuse parts 44. The plurality of the first fuse parts 44 are corresponding to the plurality of the first openings 42. Each first fuse part 44 is disposed in one first opening 42. Each first fuse part 44 is connected between one edge of the first contact plate 43 and an inner wall of the one first opening 42 of one first circular groove 41. A first current flows through the first fuse part 44 of each first base plate 40. When the first current which flows through the first fuse part 44 exceeds a first setting value, the first fuse part 44 is blown. The plurality of the first fuse parts 44 are used for protecting the plurality of the first connecting plates 4. The plurality of the first fuse parts 44 ensure a product reliability. In the first preferred embodiment, a width of each first fuse part 44 is two millimeters. In the concrete implementation, the width of each first fuse part 44 is without being limited to be two millimeters.

The plurality of the first slits 45 penetrate through middles of top surfaces and bottom surfaces of the plurality of the first contact plates 43. The plurality of the first slits 45 extend longitudinally. One end of each first slit 45 is opened freely, and the one end of each first slit 45 is communicated with one first circular groove 41. The other end of each first slit 45 is closed. The other end of each first slit 45 keeps a distance from the one first circular groove 41. In the first preferred embodiment, the other end of each first slit 45 keeps three millimeters from the one first circular groove 41. Specifically, the other end of each first slit 45 keeps three millimeters from a position of the one first circular groove 41 which is opposite to the one end of each first slit 45. The plurality of the first slits 45 are used for increasing spot soldering strengths of the plurality of the first connecting plates 4. When each first connecting plate 4 is soldered by a spot soldering technology, a first current direction of each first connecting plate 4 is an one-way loop design. The plurality of the first connecting plates 4 are difficult to accumulate the heat. The plurality of the first fuse parts 44 are difficult to break. An outer edge of each first base plate 40 is bent downward to form a first buckling portion 46. The plurality of the first buckling portions 46 of the first base plates 40 of the plurality of the first connecting plates 4 are buckled in the plurality of the first restricting portions 23 of the first bracket 2. In the first preferred embodiment, an extending direction of each first slit 45 is perpendicular to an opened direction of each first opening 42. The corresponding mechanisms of the plurality of the first connecting plates 4 are the plurality of the first buckling portions 46 of the first base plates 40 of the plurality of the first connecting plates 4.

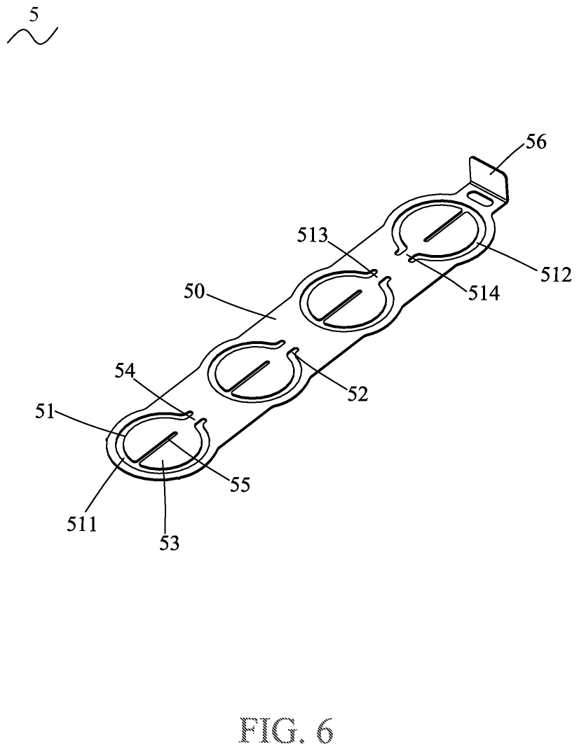

Referring to FIG. 6, each second connecting plate 5 has a second base plate 50, a plurality of second circular grooves 51, a plurality of second openings 52, a plurality of second contact plates 53, a plurality of second fuse parts 54, a plurality of second slits 55 and a second buckling portion 56. In the first preferred embodiment, the second base plate 50 is a long strip structure. The plurality of the second connecting plate 5 are long strip structures.

The plurality of the second circular grooves 51 penetrate through a top surface and a bottom surface of the second base plate 50. The plurality of the second circular grooves 51 are longitudinally arranged in a first front row 511 and a first rear row 512. In the first preferred embodiment, each second base plate 50 has four second circular grooves 51, four second openings 52, four second contact plates 53, four second fuse parts 54 and four second slits 55. The four second circular grooves 51 are defined as one group. A segment of each second circular groove 51 protrudes longitudinally to form a second opening 52. The second opening 52 is disposed longitudinally. The second opening 52 and the second slit 55 of each second base plate 50 are longitudinally disposed opposite to each other. In the first preferred embodiment, three second circular grooves 51 are longitudinally arranged in the first front row 511, and one second circular groove 51 is arranged in the first rear row 512. The three second circular grooves 51 of the first front row 511 face rearward. The one second circular groove 51 of the first rear row 512 face frontward. The plurality of the second openings 52 is arranged in a second front row 513 and a second rear row 514. Orientations of the second openings 52 of the second front row 513 is opposite to an orientation of the second opening 52 of the second rear row 514. Three second openings 52 are longitudinally arranged in the second front row 513, and one second opening 52 is arranged in the second rear row 514. The three second openings 52 of the second front row 513 are opposite to the one second opening 52 of the second rear row 514. The one second opening 52 of the second rear row 514 is close to the second buckling portion 56. A facing direction of the one second opening 52 of the second rear row 514 is opposite to a facing direction of the three second openings 52 of the second front row 513. The three second openings 52 of the second front row 513 face rearward. The one second opening 52 of the second rear row 514 faces frontward.

The plurality of the second contact plates 53 are disposed in the plurality of the second circular grooves 51. Each second contact plate 53 is corresponding to the positive electrode or the negative electrode of the one battery cell 1. Each second contact plate 53 contacts with the positive electrode or the negative electrode of the one battery cell 1. The plurality of the second contact plates 53 are connected with the second base plate 50 by the plurality of the second fuse parts 54. The plurality of the second fuse parts 54 are corresponding to the plurality of the second openings 52. Each second fuse part 54 is disposed in one second opening 52. Each second fuse part 54 is connected between one edge of the second contact plate 53 and an inner wall of the one second opening 52 of one second circular groove 51. A second current flows through each second fuse part 54. When the second current which flows through each second fuse part 54 exceeds a second setting value, each second fuse part 54 is blown in time. The plurality of the second fuse parts 54 are used for protecting the second connecting plate 5. The plurality of the second fuse parts 54 ensure the product reliability. In the first preferred embodiment, a width of each second fuse part 54 is two millimeters. In the concrete implementation, the width of each second fuse part 54 is without being limited to be two millimeters.

The plurality of the second slits 55 penetrate through middles of top surfaces and bottom surfaces of the plurality of the second contact plates 53. One end of each second slit 55 is opened freely, and the one end of each second slit 55 is communicated with one second circular groove 51. The other end of each second slit 55 is closed. The other end of each second slit 55 keeps a distance from the one second circular groove 51. In the first preferred embodiment, the other end of each second slit 55 keeps three millimeters from the one second circular groove 51. Specifically, the other end of each second slit 55 keeps three millimeters from a position of the one second circular groove 51 which is opposite to the one end of each second slit 55. An extending direction of each second slit 55 is in alignment with an extending direction of each second opening 52. The plurality of the second slits 55 are used for increasing spot soldering strengths of the plurality of the second connecting plates 5. When each second connecting plate 5 is soldered by the spot soldering technology, a second current direction of each second connecting plate 5 is the one-way loop design. The plurality of the second connecting plates 5 are difficult to accumulate the heat. The plurality of the second fuse parts 54 are difficult to break. A rear end of each second base plate 50 is bent upward to form the second buckling portion 56. The plurality of the second buckling portions 56 are buckled in the plurality of the second restricting portions 32 of the second bracket 3. The corresponding mechanisms of the plurality of the second connecting plates 5 are the plurality of the second buckling portions 56 of the plurality of the second connecting plates 5. The orientation of the second opening 52 which is adjacent to the second buckling portion 56 of each second connecting plate 5 is opposite to the orientations of the other second openings 52 of each second connecting plate 5.

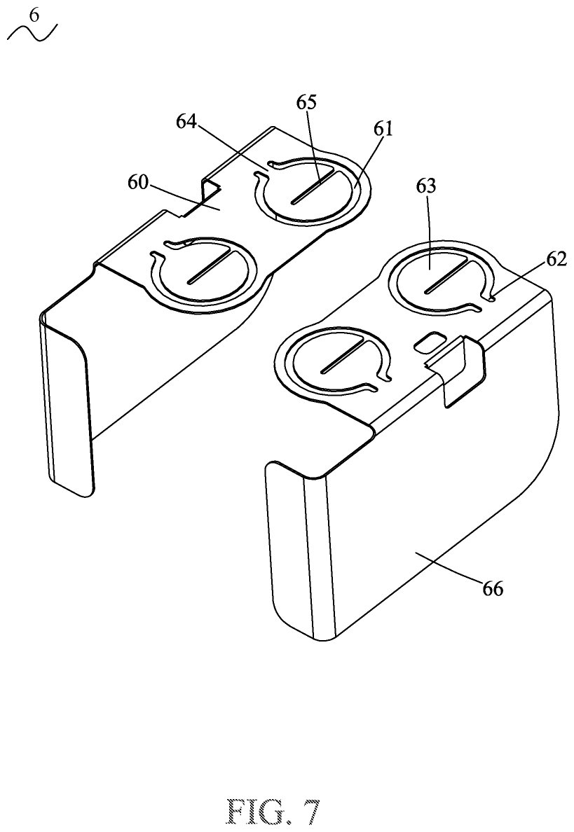

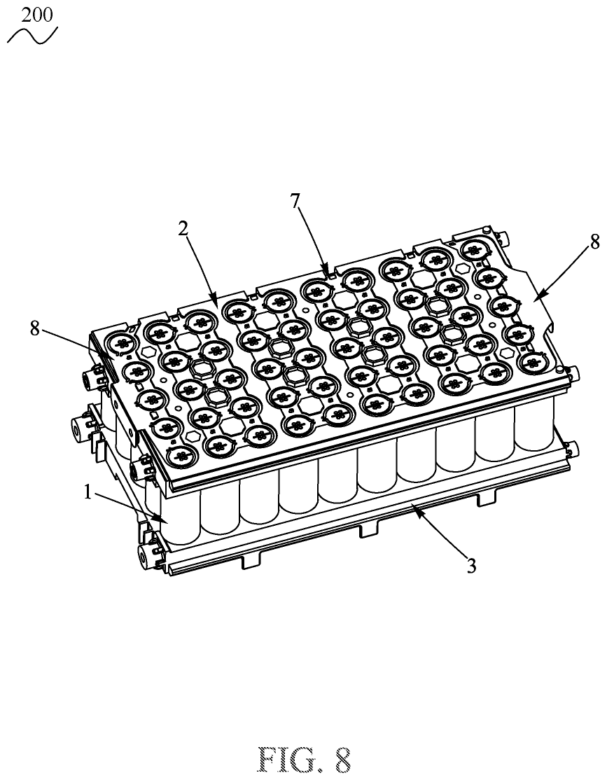

Referring to FIG. 1, FIG. 4, FIG. 7 and FIG. 8, the two third connecting plates 6 are disposed to a left side and a right side of the first bracket 2. the two third connecting plates 6 are disposed to two opposite sides of the plurality of the first connecting plates 4. Each third connecting plate 6 has a third base plate 60, a plurality of third circular grooves 61, a plurality of third openings 62, a plurality of third contact plates 63, a plurality of third fuse parts 64, a plurality of third slits 65, and a first current collecting portion 66 extended downward from an outer side of the third base plate 60.

The plurality of the third circular grooves 61 penetrate through a top surface and a bottom surface of the third base plate 60. In the first preferred embodiment, each third base plate 60 has two third circular grooves 61, two third openings 62, two third contact plates 63, two third fuse parts 64 and two third slits 65. A segment of each third circular groove 61 protrudes outward and transversely to form a third opening 62. In the first preferred embodiment, the two third base plates 60 are disposed to the two opposite sides of the first bracket 2. The plurality of the third openings 62 of the third base plates 60 of the two third connecting plates 6 face outward. The two third openings 62 of the third base plate 60 of the third connecting plate 6 which is located at the right side of the first bracket 2 face rightward. The two third openings 62 of the third base plate 60 of the third connecting plate 6 which is located at the left side of the first bracket 2 face leftward.

The plurality of the third contact plates 63 are disposed in the plurality of the third circular grooves 61. Each third contact plate 63 is corresponding to the positive electrode or the negative electrode of the one battery cell 1. Each third contact plate 63 contacts with the positive electrode or the negative electrode of the one battery cell 1. The plurality of the third contact plates 63 are connected with the third base plate 60 by the plurality of the third fuse parts 64. The plurality of the third fuse parts 64 are corresponding to the plurality of the third openings 62. Each third fuse part 64 is disposed in one third opening 62. Each third fuse part 64 is connected between one edge of the third contact plate 63 and an inner wall of the one third opening 62 of one third circular groove 61. A third current flows through each third fuse part 64. When the third current which flows through each third fuse part 64 exceeds a third setting value, each third fuse part 64 is blown in time. The plurality of the third fuse parts 64 are used for protecting the two third connecting plates 6. The plurality of the third fuse parts 64 ensure the product reliability. In the first preferred embodiment, a width of each third fuse part 64 is two millimeters. In the concrete implementation, the width of each third fuse part 64 is without being limited to be two millimeters.

The plurality of the third slits 65 penetrate through middles of top surfaces and bottom surfaces of the plurality of the third contact plates 63. One end of each third slit 65 is opened freely, and the one end of each third slit 65 is communicated with one third circular groove 61. The other end of each third slit 65 is closed. The other end of each third slit 65 keeps a distance from the one third circular groove 61. In the first preferred embodiment, the other end of each third slit 65 keeps three millimeters from the one third circular groove 61. Specifically, the other end of each third slit 65 keeps three millimeters from a position of the one third circular groove 61 which is opposite to the one end of each third slit 65. An extending direction of each third slit 65 is perpendicular to an extending direction of each third opening 62. The plurality of the third slits 65 are used for increasing spot soldering strengths of the two third connecting plates 6. When each third connecting plate 6 is soldered by the spot soldering technology, a third current direction of each third connecting plate 6 is the one-way loop design. The two third connecting plates 6 are difficult to accumulate the heat. The plurality of the third fuse parts 64 are difficult to break.

The outer side of each third base plate 60 extends downward to form the first current collecting portion 66. A front end of the first current collecting portion 66 is bent inward. The two first current collecting portions 66 are disposed to the two opposite sides of the first bracket 2. Currents of the plurality of the battery cells 1 are collected at the two first current collecting portions 66 of the two third connecting plates 6, and then the currents of the plurality of the battery cells 1 flow thoroughly to external electronic components, or the currents of the external electronic components are flowed thoroughly to the plurality of the battery cells 1 by the two first current collecting portions 66 of the two third connecting plates 6. The third openings 62 of the two third base plates 60 of the two third connecting plates 6 face towards the two first current collecting portions 66 of the two third connecting plates 6.

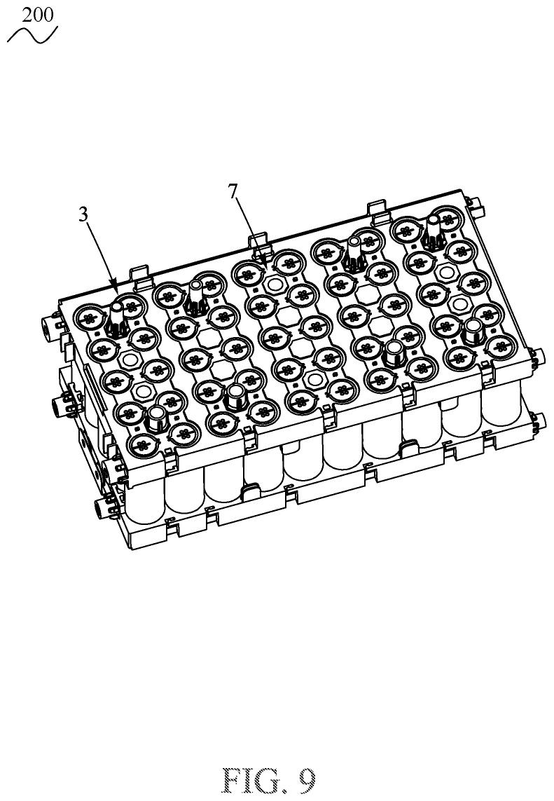

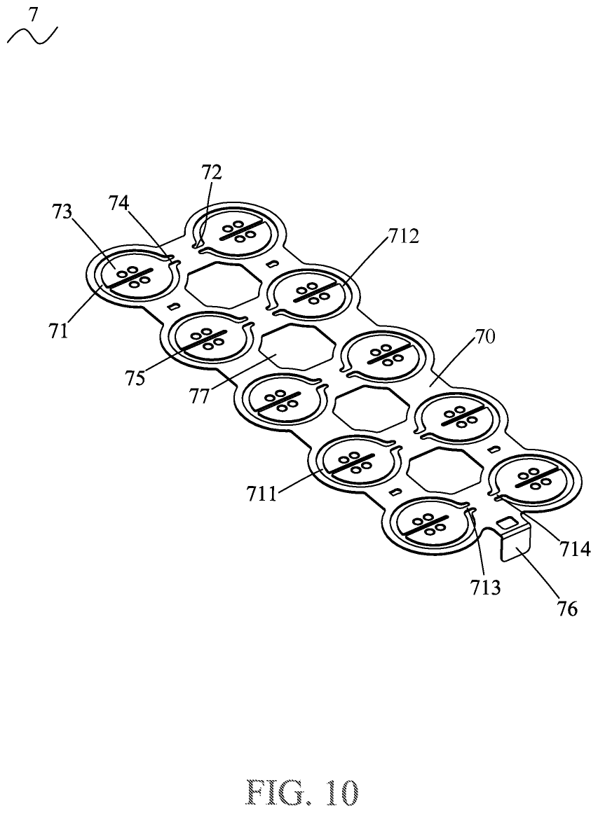

Referring to FIG. 1 to FIG. 11, a battery module 200 in accordance with a second preferred embodiment of the present invention is shown. Differences between the battery module 100 in accordance with the first preferred embodiment and the battery module 200 in accordance with the second preferred embodiment are described as follows.

Referring to FIG. 8 to FIG. 10, the battery module 200 includes the plurality of the battery cells 1, the first bracket 2, the second bracket 3, a plurality of first connecting pieces 7 and two second connecting pieces 8. The plurality of the first connecting pieces 7 are disposed to the top surface of the first bracket 2 and the bottom surface of the second bracket 3. The plurality of the first connecting pieces 7 are disposed to the top surfaces and the bottom surfaces of the plurality of the battery cells 1. The two second connecting pieces 8 are disposed to the top surfaces of the plurality of the battery cells 1. The two second connecting pieces 8 are disposed to two opposite sides of the plurality of the first connecting pieces 7.

Each first connecting piece 7 has a first base slice 70, a plurality of first circular spaces 71, a plurality of first gaps 72, a plurality of first contact slices 73, a plurality of first fuse elements 74, a plurality of first slots 75, a first fastening portion 76 and a plurality of first locating grooves 77. In the second preferred embodiment, the first base slice 70 is a rectangular strip structure. The plurality of the first connecting pieces 7 are the long strip structures. In the second preferred embodiment, four first connecting pieces 7 and the two second connecting pieces 8 are disposed on the top surface of the first bracket 2. The two second connecting pieces 8 are disposed at the two opposite sides of the first bracket 2. Five first connecting pieces 7 are disposed to the bottom surface of the second bracket 3.

The plurality of the first circular spaces 71 penetrate through a top surface and a bottom surface of the first base slice 70. The plurality of the first circular spaces 71 are arranged in a first left line 711 and a first right line 712. In the second preferred embodiment, each first base slice 70 has ten first circular spaces 71, ten first gaps 72, ten first contact slices 73, ten first fuse elements 74, ten first slots 75 and four first locating grooves 77. The ten first circular spaces 71 are defined as a group which is disposed to the first base slice 70. Five first circular spaces 71 are longitudinally arranged in the first left line 711, and the other five first circular spaces 71 are longitudinally arranged in the first right line 712. The five first circular spaces 71 of the first left line 711 are disposed to a left side of the first base slice 70. The other five first circular spaces 71 of the first right line 712 are disposed to a right side of the first base slice 70.

A segment of each first circular space 71 protrudes transversely to form a first gap 72. Orientations of the first gaps 72 of the five first circular spaces 71 of the first left line 711 are the same. Orientations of the first gaps 72 of the other five first circular spaces 71 of the first right line 712 are the same. The orientations of the first gaps 72 of the five first circular spaces 71 of the first left line 711 are opposite to the orientations of the first gaps 72 of the other five first circular spaces 71 of the first right line 712. In the second preferred embodiment, the first gaps 72 of the five first circular spaces 71 of the first left line 711 face rightward. The first gaps 72 of the other five first circular spaces 71 of the first right line 712 face leftward. The first gaps 72 of the five first circular spaces 71 of the first left line 711 face the first gaps 72 of the other five first circular spaces 71 of the first right line 712.

The five first gaps 72 of the five first circular spaces 71 of the first left line 711 are longitudinally arranged in a second left line 713, and the other five first gaps 72 of the other five first circular spaces 71 of the first right line 712 are longitudinally arranged in a second right line 714. In the second preferred embodiment, the five first gaps 72 of the second left line 713 are formed by the five first circular spaces 71 of the first right line 712. The other five first gaps 72 of the second right line 714 are formed by the other five first circular spaces 71 of the first left line 711. The orientations of the five first gaps 72 of the second left line 713 are the same. The orientations of the other five first gaps 72 of the second right line 714 are the same. The orientations of the five first gaps 72 of the second left line 713 are opposite to the orientations of the other five first gaps 72 of the second right line 714. In the second preferred embodiment, the five first gaps 72 of the second left line 713 face rightward. The other five first gaps 72 of the second right line 714 face leftward.

The plurality of the first contact slices 73 are disposed in the plurality of the first circular spaces 71. Each first contact slice 73 is corresponding to the positive electrode or the negative electrode of the one battery cell 1. Each first contact slice 73 contacts with the positive electrode or the negative electrode of the one battery cell 1. The plurality of the first contact slices 73 are connected with the first base slice 70 by the plurality of the first fuse elements 74. The plurality of the first fuse elements 74 are corresponding to the plurality of the first gaps 72. Each first fuse element 74 is disposed in one first gap 72. Each first fuse element 74 is connected between one edge of the first contact slice 73 and an inner wall of the one first gap 72 of one first circular space 71. A fourth current flows through the first fuse element 74 of each first base slice 70. When the fourth current which flows through the first fuse element 74 exceeds a fourth setting value, the first fuse element 74 is blown in time. The plurality of the first fuse elements 74 are used for protecting the plurality of the first connecting pieces 7. The plurality of the first fuse elements 74 ensure the product reliability. In the second preferred embodiment, a width of each first fuse element 74 is two millimeters. In the concrete implementation, the width of each first fuse element 74 is without being limited to be two millimeters.

The plurality of the first slots 75 penetrate through middles of top surfaces and bottom surfaces of the plurality of the first contact slices 73. One end of each first slot 75 is opened freely, and the one end of each first slot 75 is communicated with one first circular space 71. The other end of each first slot 75 is closed. The other end of each first slot 75 keeps a distance from the one first circular space 71. In the second preferred embodiment, the other end of each first slot 75 keeps three millimeters from the one first circular space 71. Specifically, the other end of each first slot 75 keeps three millimeters from a position of the one first circular space 71 which is opposite to the one end of each first slot 75. An extending direction of each first slot 75 is in alignment with an extending direction of each first gap 72. The plurality of the first slots 75 are used for increasing spot soldering strengths of the plurality of the first connecting pieces 7. When each first connecting piece 7 is soldered by the spot soldering technology, a fourth current direction of each first connecting piece 7 is the one-way loop design. The plurality of the first connecting pieces 7 are difficult to accumulate the heat. The plurality of the first fuse elements 74 are difficult to break.

A rear edge of the first base slice 70 is bent downward to form the first fastening portion 76. The rear of the top surface of the first bracket 2 are recessed downward to form the plurality of the first restricting portions 23. A quantity of the plurality of the first restricting portions 23 of the first bracket 2 according to the first preferred embodiment is different from a quantity of the plurality of the first restricting portions 23 of the first bracket 2 according to the second preferred embodiment. The first fastening portions 76 of the first connecting pieces 7 which are disposed to the bottom surface of the second bracket 3 are buckled in the plurality of the second restricting portions 32 of the second bracket 3. A quantity of the plurality of the second restricting portions 32 of the second bracket 3 according to the first preferred embodiment is different from a quantity of the plurality of the second restricting portions 32 of the second bracket 3 according to the second preferred embodiment. The plurality of the first locating grooves 77 penetrate through the top surface and the bottom surface of the first base slice 70. In the second preferred embodiment, each first locating groove 77 is disposed among four adjacent first circular spaces 71. Each first locating groove 77 is formed at a middle area among four adjacent first circular spaces 71. The plurality of the first locating grooves 77 of the plurality of the first connecting pieces 7 are located to the first bracket 2 and the second bracket 3.

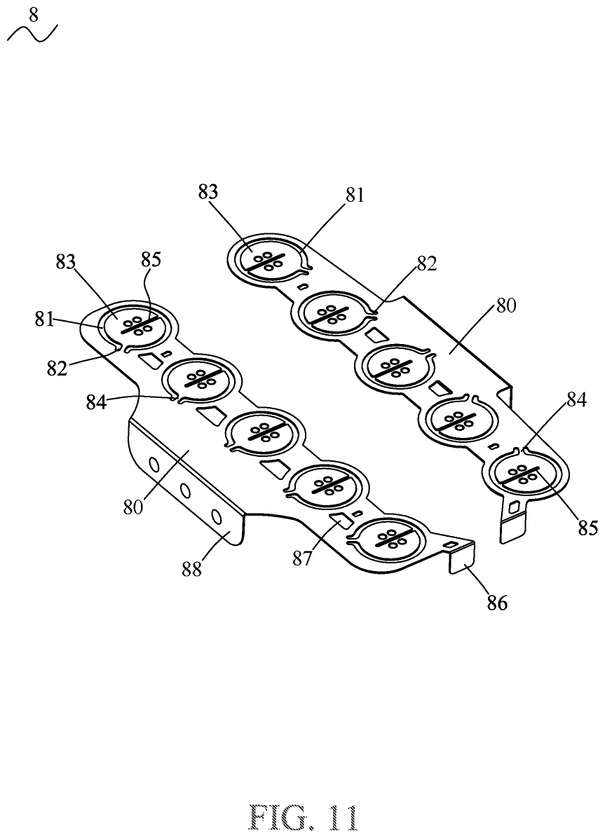

Referring to FIG. 11, each second connecting piece 8 has a second base slice 80, a plurality of second circular spaces 81, a plurality of second gaps 82, a plurality of second contact slices 83, a plurality of second fuse elements 84, a plurality of second slots 85, a second fastening portion 86, a plurality of second locating grooves 87, and a second current collecting portion 88 extended downward from an outer side of the second base slice 80.

The plurality of the second circular spaces 81 penetrate through a top surface and a bottom surface of the second base slice 80. In the second preferred embodiment, each second base slice 80 has five second circular spaces 81, five second gaps 82, five second contact slices 83, five second fuse elements 84, five second slots 85 and four second locating grooves 87. The five second circular spaces 81 are defined as a group which is disposed to the second base slice 80. A segment of each second circular space 81 protrudes outward to form a second gap 82. The two second connecting pieces 8 are disposed to two opposite sides of the first bracket 2. The two second connecting pieces 8 are disposed at the left side and the right side of the first bracket 2. The five second gaps 82 of the second base slice 80 of the second connecting piece 8 disposed at the left side of the first bracket 2 face leftward. The five second gaps 82 of the second base slice 80 of the second connecting piece 8 disposed at the right side of the first bracket 2 face rightward. The second gaps 82 of the two second base slices 80 of the two second connecting pieces 8 face outward.

The second gaps 82 of the two second base slices 80 of the two second connecting pieces 8 face towards the two second current collecting portions 88 of the two second connecting pieces 8. In the second preferred embodiment, the five second gaps 82 of the second base slice 80 of the second connecting piece 8 disposed at the left side of the first bracket 2 face the second current collecting portion 88 of the second connecting piece 8 disposed at the left side of the first bracket 2. The five second gaps 82 of the second base slice 80 of the second connecting piece 8 disposed at the right side of the first bracket 2 face the second current collecting portion 88 of the second connecting piece 8 disposed at the right side of the first bracket 2. Furthermore, two front second gaps 82 of the second base slice 80 of the second connecting piece 8 disposed at the left side of the first bracket 2 face leftward and rearward, the middle second gap 82 of the second base slice 80 of the second connecting piece 8 disposed at the left side of the first bracket 2 horizontally face leftward, and two rear second gaps 82 of the second base slice 80 of the second connecting piece 8 disposed at the left side of the first bracket 2 face leftward and frontward. Two front second gaps 82 of the second base slice 80 of the second connecting piece 8 disposed at the right side of the first bracket 2 face rightward and rearward, the middle second gap 82 of the second base slice 80 of the second connecting piece 8 disposed at the right side of the first bracket 2 horizontally face rightward, and two rear second gaps 82 of the second base slice 80 of the second connecting piece 8 disposed at the right side of the first bracket 2 face rightward and frontward.

The plurality of the second contact slices 83 are disposed in the plurality of the second circular spaces 81. Each second contact slice 83 is corresponding to the positive electrode or the negative electrode of the one battery cell 1. Each second contact slice 83 contacts with the positive electrode or the negative electrode of the one battery cell 1. The plurality of the second contact slices 83 are connected with the second base slice 80 by the plurality of the second fuse elements 84. The plurality of the second fuse elements 84 are corresponding to the plurality of the second gaps 82. Each second fuse element 84 is disposed in one second gap 82. Each second fuse element 84 is connected between one edge of the second contact slice 83 and an inner wall of the one second gap 82 of one second circular space 81. The fifth current flows through the second fuse element 84 of each second base slice 80. When the fifth current which flows through the second fuse element 84 exceeds a fifth setting value, the second fuse element 84 is blown in time. The plurality of the second fuse elements 84 are used for protecting the plurality of the second connecting pieces 8. The plurality of the second fuse elements 84 ensure the product reliability. In the second preferred embodiment, a width of each second fuse element 84 is two millimeters. In the concrete implementation, the width of each second fuse element 84 is without being limited to be two millimeters.

The plurality of the second slots 85 penetrate through middles of top surfaces and bottom surfaces of the plurality of the second contact slices 83. One end of each second slot 85 is opened freely, and the one end of each second slot 85 is communicated with one second circular space 81. The other end of each second slot 85 is closed. The other end of each second slot 85 keeps a distance from the one second circular space 81. In the second preferred embodiment, the other end of each second slot 85 keeps three millimeters from the one second circular space 81. Specifically, the other end of each second slot 85 keeps three millimeters from a position of the one second circular space 81 which is opposite to the one end of each second slot 85. The plurality of the second slots 85 are used for increasing spot soldering strengths of the plurality of the second connecting pieces 8. When each second connecting piece 8 is soldered by the spot soldering technology, a fifth current direction of each second connecting piece 8 is the one-way loop design. The plurality of the second connecting pieces 8 are difficult to accumulate the heat. The plurality of the second fuse elements 84 are difficult to break.

A rear edge of the second base slice 80 is bent downward to form the second fastening portion 86. The first fastening portions 76 of the first connecting pieces 7 which are disposed on the top surface of the first bracket 2, and the two second fastening portions 86 of the two second connecting pieces 8 are buckled in the first restricting portions 23 of the first bracket 2. The plurality of the second locating grooves 87 penetrate through the top surface and the bottom surface of the second base slice 80. In the second preferred embodiment, each second locating groove 87 of one second connecting piece 8 is disposed between two adjacent second circular spaces 81. Each second locating groove 87 of the other second connecting piece 8 is disposed between a middle second circular space 81 and the second circular space 81 which is adjacent to the middle second circular space 81. The plurality of the second locating grooves 87 of the two second connecting pieces 8 are located to the first bracket 2. An outer side of each second base slice 80 extends downward to form the second current collecting portion 88. The two second current collecting portions 88 are disposed to the two opposite sides of the first bracket 2. The two second current collecting portions 88 of the two second connecting pieces 8 are disposed to the left side and the right side of the first bracket 2. The currents of the plurality of the battery cells 1 are collected at the two second current collecting portions 88 of the two second connecting pieces 8, and then the currents of the plurality of the battery cells 1 flow thoroughly to the external electronic components, or the currents of the external electronic components are flowed thoroughly to the plurality of the battery cells 1 by the two second current collecting portions 88 of the two second connecting pieces 8.

As described above, the first current direction of each first connecting plate 4 is the one-way loop design, the second current direction of each second connecting plate 5 is the one-way loop design, and the third current direction of each third connecting plate 6 is the one-way loop design by designs of the first slit 45 of each first connecting plate 4, the second slit 55 of each second connecting plate 5 and the third slit 65 of each third connecting plate 6 of the battery module 100, so the plurality of the first connecting plates 4, the plurality of the second connecting plates 5 and the two third connecting plates 6 are difficult to accumulate the heat. The fourth current direction of each first connecting piece 7 is the one-way loop design, and the fifth current direction of each second connecting piece 8 is the one-way loop design by designs of the first slot 75 of each first connecting piece 7 and the second slot 85 of each second connecting piece 8 of the battery module 200, so the plurality of the first connecting pieces 7 and the plurality of the second connecting pieces 8 are difficult to accumulate the heat. The plurality of the first fuse parts 44, the plurality of the second fuse parts 54 and the plurality of the third fuse parts 64 are difficult to break, so the battery module 100 has a better current dividing effect of spot soldering and a better tension soldering effect. The plurality of the first fuse elements 74 and the plurality of the second fuse elements 84 are difficult to break, so the battery module 200 has the better current dividing effect of spot soldering and the better tension soldering effect. Furthermore, the third openings 62 of the two third base plates 60 of the two third connecting plates 6 face towards the two first current collecting portions 66 of the two third connecting plates 6, so that the currents of the external electronic components averagely flow through the third openings 62 of the two third connecting plates 6. The second gaps 82 of the two second base slices 80 of the two second connecting pieces 8 face towards the two second current collecting portions 88 of the two second connecting pieces 8, so that the currents of the external electronic components averagely flow through the second gaps 82 of the two second connecting pieces 8.

What is claimed is:

1. A battery module, comprising:
a plurality of battery cells;
a first bracket disposed to top surfaces of the plurality of the battery cells;
a second bracket disposed to bottom surfaces of the plurality of the battery cells;
a plurality of first connecting plates disposed to a top surface of the first bracket, each first connecting plate having
a first base plate being a substantially rectangular structure,
a plurality of first circular grooves penetrating through a top surface and a bottom surface of the first base plate, the plurality of the first circular grooves being arranged in a first left row and a first right row,
a plurality of first openings, a segment of each first circular groove protruding transversely to form a first opening, orientations of the first openings of the first circular grooves of the first left row being the same, orientations of the first openings of the first circular grooves of the first right row being the same, the orientations of the first openings of the first circular grooves of the first left row being opposite to the orientations of the first openings of the first circular grooves of the first right row, the first openings of the first circular grooves of the first left row being longitudinally arranged in a second left row, and the first openings of the first circular grooves of the first right row being longitudinally arranged in a second right row, the first openings of the second left row facing towards the first openings of the second right row,
a plurality of first fuse parts corresponding to the plurality of the first openings, each first fuse part being disposed in one first opening,
a plurality of first contact plates disposed in the plurality of the first circular grooves, each first contact plate contacting with a positive electrode or a negative electrode of one battery cell, and
a plurality of first slits penetrating through middles of top surfaces and bottom surfaces of the plurality of the first contact plates, one end of each first slit being opened freely, and the one end of each first slit being communicated with one first circular groove, the other end of each first slit being closed, the other end of each first slit keeping a distance from the one first circular groove;
a plurality of second connecting plates disposed to a bottom surface of the second bracket, each second connecting plate having:
a second base plate being a long strip structure,
a plurality of second circular grooves penetrating through a top surface and a bottom surface of the second base plate, the plurality of the second circular grooves being longitudinally arranged in a first front row and a first rear row,
a plurality of second openings, a segment of each second circular groove protruding longitudinally to form a second opening, the plurality of the second openings being arranged in a second front row and a second rear row, orientations of the second openings of the second front row being opposite to an orientation of the second opening of the second rear row, the second openings of the second front row facing rearward, the second opening of the second rear row facing frontward,
a plurality of second fuse parts corresponding to the plurality of the second openings, each second fuse part being disposed in one second opening,
a plurality of second contact plates disposed in the plurality of the second circular grooves, each second contact plate contacting with the positive electrode or the negative electrode of the one battery cell, and
a plurality of second slits penetrating through middles of top surfaces and bottom surfaces of the plurality of the second contact plates, one end of each second slit being opened freely, and the one end of each second slit being communicated with one second circular groove, the other end of each second slit being closed, the other end of each second slit keeping a distance from the one second circular groove; and
two third connecting plates disposed to two opposite sides of the first bracket, the two third connecting plates being disposed to two opposite sides of the plurality of the first connecting plates, each third connecting plate having:
a third base plate,
a first current collecting portion extended downward from an outer side of the third base plate,
a plurality of third circular grooves penetrating through a top surface and a bottom surface of the third base plate,
a plurality of third openings, a segment of each third circular groove protruding outward and transversely to form a third opening, the third openings of the two third base plates of the two third connecting plates facing towards the two first current collecting portions of the two third connecting plates,
a plurality of third fuse parts corresponding to the plurality of the third openings, each third fuse part being disposed in one third opening,
a plurality of third contact plates disposed in the plurality of the third circular grooves, each third contact plate contacting with the positive electrode or the negative electrode of the one battery cell, and
a plurality of third slits penetrating through middles of top surfaces and bottom surfaces of the plurality of the third contact plates, one end of each third slit being opened freely, and the one end of each third slit being communicated with one third circular groove, the other end of each third slit being closed, the other end of each third slit keeping a distance from the one third circular groove.

2. The battery module as claimed in claim 1, wherein the plurality of the first contact plates are connected with the first base plate by the plurality of the first fuse parts, each first fuse part is connected between one edge of the first contact plate and an inner wall of the one first opening of the one first circular groove, the plurality of the second contact plates are connected with the second base plate by the plurality of the second fuse parts, each second fuse part is connected between one edge of the second contact plate and an inner wall of the one second opening of the one second circular groove, the plurality of the third contact plates are connected with the third base plate by the plurality of the third fuse parts, each third fuse part is connected between one edge of the third contact plate and an inner wall of the one third opening of the one third circular groove.

3. The battery module as claimed in claim 1, wherein the first openings of the second left row face towards a rightward direction, the first openings of the second right row face towards a leftward direction, the second openings of the second front row face rearward, the second opening of the second rear row faces frontward, the two third connecting plates are disposed to a left side and a right side of the first bracket, the third openings of the third base plate of the third connecting plate which is located at the right side of the first bracket face rightward, the third openings of the third base plate of the third connecting plate which is located at the left side of the first bracket face leftward.

4. The battery module as claimed in claim 1, wherein several portions of the top surface of the first bracket are recessed downward to form a plurality of first concave surfaces, the plurality of the first connecting plates are disposed on the plurality of the first concave surfaces, two rears of two opposite sides of the top surface of the first bracket are recessed downward to form two second concave surfaces, the two third connecting plates are disposed on the two second concave surfaces.

5. The battery module as claimed in claim 4, wherein an outer end of each first concave surface is recessed downward to form a first restricting portion, an outer edge of each first base plate is bent downward to form a first buckling portion, the plurality of the first buckling portions of the plurality of the first connecting plates are buckled in the plurality of the first restricting portions of the first bracket.

6. The battery module as claimed in claim 5, wherein several portions of a bottom surface of the second bracket are recessed upward to from a plurality of third concave surfaces, the plurality of the second connecting plates are disposed at the plurality of the third concave surfaces.

7. The battery module as claimed in claim 6, wherein one end of the third concave surface is recessed upward to form a second restricting portion, a rear end of each second base plate is bent upward to form a second buckling portion, the plurality of the second buckling portions of the plurality of the second connecting plates are buckled in the plurality of the second restricting portions of the second bracket.

8. The battery module as claimed in claim 7, wherein the orientation of the second opening which is adjacent to the second buckling portion of each second connecting plate is opposite to the orientations of the other second openings of each second connecting plate.

9. A battery module, comprising:
a plurality of battery cells;
a first bracket disposed to top surfaces of the plurality of the battery cells;
a second bracket disposed to bottom surfaces of the plurality of the battery cells;
a plurality of first connecting pieces disposed to the top surface of the first bracket and the bottom surface of the second bracket, each first connecting piece having
a first base slice being a rectangular strip structure,
a plurality of first circular spaces penetrating through a top surface and a bottom surface of the first base slice, the plurality of the first circular spaces being arranged in a first left line and a first right line,
a plurality of first gaps, a segment of each first circular space protruding transversely to form a first gap, orientations of the first gaps of the first circular spaces of the first left line being the same, orientations of the first gaps of the first circular spaces of the first right line being the same, the orientations of the first gaps of the first circular spaces of the first left line being opposite to the orientations of the first gaps of the first circular spaces of the first right line,
a plurality of first contact slices disposed in the plurality of the first circular spaces, each first contact slice contacting with the positive electrode or the negative electrode of the one battery cell,
a plurality of first fuse elements corresponding to the plurality of the first gaps, each first fuse element being disposed in one first gap, and
a plurality of first slots penetrating through middles of top surfaces and bottom surfaces of the plurality of the first contact slices, one end of each first slot being opened freely, and the one end of each first slot being communicated with one first circular space, the other end of each first slot being closed, the other end of each first slot keeping a distance from the one first circular space; and
two second connecting pieces disposed at a left side and a right side of the first bracket, the two second connecting pieces being disposed to two opposite sides of the plurality of first connecting pieces, each second connecting piece having:
a second base slice,
a second current collecting portion extended downward from an outer side of the second base slice,
a plurality of second circular spaces penetrating through a top surface and a bottom surface of the second base slice,
a plurality of second gaps, a segment of each second circular space protruding outward to form a second gap, the second gaps of the two second base slices of the two second connecting pieces facing towards the two second current collecting portions of the two second connecting pieces,
a plurality of second contact slices disposed in the plurality of the second circular spaces, each second contact slice contacting with the positive electrode or the negative electrode of the one battery cell,
a plurality of second fuse elements corresponding to the plurality of the second gaps, each second fuse element being disposed in one second gap, and
a plurality of second slots penetrating through middles of top surfaces and bottom surfaces of the plurality of the second contact slices, one end of each second slot being opened freely, and the one end of each second slot being communicated with one second circular space, the other end of each second slot being closed, the other end of each second slot keeping a distance from the one second circular space.

10. The battery module as claimed in claim 9, wherein each second base slice has five second circular spaces, the five second circular spaces are defined as a group which is disposed to the second base slice, two front second gaps of the second base slice of the second connecting piece disposed at the left side of the first bracket face leftward and rearward, the middle second gap of the second base slice of the second connecting piece disposed at the left side of the first bracket horizontally face leftward, and two rear second gaps of the second base slice of the second connecting piece disposed at the left side of the first bracket face leftward and frontward, two front second gaps of the second base slice of the second connecting piece disposed at the right side of the first bracket face rightward and rearward, the middle second gap of the second base slice of the second connecting piece disposed at the right side of the first bracket horizontally face rightward, and two rear second gaps of the second base slice of the second connecting piece disposed at the right side of the first bracket face rightward and frontward.

11. The battery module as claimed in claim 9, wherein the plurality of the first contact slices are connected with the first base slice by the plurality of the first fuse elements, each first fuse element is connected between one edge of the first contact slice and an inner wall of the one first gap of the one first circular space, the plurality of the second contact slices are connected with the second base slice by the plurality of the second fuse elements, each second fuse element is connected between one edge of the second contact slice and an inner wall of the one second gap of the one second circular space.

12. The battery module as claimed in claim 9, wherein each first connecting piece has a plurality of first locating grooves penetrating through the top surface and the bottom surface of the first base slice, each first locating groove is disposed among four adjacent first circular spaces, the plurality of the first locating grooves of the plurality of the first connecting pieces are located to the first bracket and the second bracket.

13. The battery module as claimed in claim 12, wherein each second connecting piece has a plurality of second locating grooves penetrating through the top surface and the bottom surface of the second base slice, each second locating groove of one second connecting piece is disposed between two adjacent second circular spaces, each second locating groove of the other second connecting piece is disposed between a middle second circular space and the second circular space which is adjacent to the middle second circular space, the plurality of the second locating grooves of the two second connecting pieces are located to the first bracket.

14. The battery module as claimed in claim 9, wherein the two second current collecting portions of the two second connecting pieces are disposed to the left side and the right side of the first bracket.

15. The battery module as claimed in claim 9, wherein a rear of the top surface of the first bracket are recessed downward to form a plurality of first restricting portions, a rear edge of the first base slice is bent downward to form a first fastening portion, a rear edge of the second base slice is bent downward to form a second fastening portion, the first fastening portions of the first connecting pieces which are disposed on the top surface of the first bracket, and the two second fastening portions of the two second connecting pieces are buckled in the first restricting portions of the first bracket.

16. The battery module as claimed in claim 15, wherein a rear of the bottom surface of the second bracket are recessed upward to form a plurality of second restricting portions, the first fastening portions of the first connecting pieces which are disposed to the bottom surface of the second bracket are buckled in the plurality of the second restricting portions of the second bracket.

17. A battery module, comprising:
a plurality of battery cells;
a first bracket disposed to top surfaces of the plurality of the battery cells;
a second bracket disposed to bottom surfaces of the plurality of the battery cells;
a plurality of first connecting pieces disposed to the top surface of the first bracket and the bottom surface of the second bracket, each first connecting piece having
a first base slice,
a plurality of first circular spaces penetrating through a top surface and a bottom surface of the first base slice, the plurality of the first circular spaces being arranged in a first left line and a first right line,
a plurality of first gaps, a segment of each first circular space protruding transversely to form a first gap, orientations of the first gaps of the first circular spaces of the first left line being the same, orientations of the first gaps of the first circular spaces of the first right line being the same, the orientations of the first gaps of the first circular spaces of the first left line being opposite to the orientations of the first gaps of the first circular spaces of the first right line,
a plurality of first contact slices disposed in the plurality of the first circular spaces, each first contact slice contacting with the positive electrode or the negative electrode of the one battery cell,
a plurality of first fuse elements, each first fuse element being disposed in one first gap,
a plurality of first slots penetrating through middles of top surfaces and bottom surfaces of the plurality of the first contact slices, one end of each first slot being opened freely, and the one end of each first slot being communicated with one first circular space, the other end of each first slot being closed, the other end of each first slot keeping a distance from the one first circular space, and
a plurality of first locating grooves penetrating through the top surface and the bottom surface of the first base slice, each first locating groove being disposed among four adjacent first circular spaces, the plurality of the first locating grooves of the plurality of the first connecting pieces being located to the first bracket and the second bracket; and
two second connecting pieces disposed at a left side and a right side of the first bracket, the two second connecting pieces being disposed to two opposite sides of the plurality of first connecting pieces, each second connecting piece having:
a second base slice,
a second current collecting portion extended downward from an outer side of the second base slice,
a plurality of second circular spaces penetrating through a top surface and a bottom surface of the second base slice,
a plurality of second gaps, a segment of each second circular space protruding outward to form a second gap, the second gaps of the two second base slices of the two second connecting pieces facing towards the two second current collecting portions of the two second connecting pieces,
a plurality of second contact slices disposed in the plurality of the second circular spaces, each second contact slice contacting with the positive electrode or the negative electrode of the one battery cell,
a plurality of second fuse elements, each second fuse element being disposed in one second gap, and
a plurality of second slots penetrating through middles of top surfaces and bottom surfaces of the plurality of the second contact slices, one end of each second slot being opened freely, and the one end of each second slot being communicated with one second circular space, the other end of each second slot being closed, the other end of each second slot keeping a distance from the one second circular space.

18. The battery module as claimed in claim 17, wherein the first base slice is a rectangular strip structure.
